(19) United States
(12) Patent Application Publication
(10) Pub. No.: US 2016/0325930 A1
(43) Pub. Date: Nov. 10, 2016

(54) CINCHABLE GROUND SHEET AND LOOP KIT

(71) Applicant: Allsop, Inc., Bellingham, WA (US)

(72) Inventor: James D. Allsop, Bellingham, WA (US)

(21) Appl. No.: 15/147,294

(22) Filed: May 5, 2016

Related U.S. Application Data
(60) Provisional application No. 62/179,486, filed on May 7, 2015.

(51) Int. Cl. B65F 1/00; B65D 33/16

(52) U.S. Cl. CPC B65F 1/0006; B65D 33/1633; B65F 2240/138

(57) ABSTRACT

In at least some embodiments, a ground sheet assembly includes a portable ground sheet having a first section and a plurality of additional sections. The ground sheet assembly includes a first loop coupled to the first section and a plurality of additional loops coupled to each of the additional sections of the ground sheet. After material is placed on the ground sheet, the first loop is operable to bring the first section together with the plurality of additional sections when the first loop is passed through each of the additional loops. The loops may be attached to corner sections of the ground sheet or attached to other sections. The first loop operates as a handle to carry the ground sheet assembly after cinching.

### PRIORITY CLAIM

This application claims the benefit of U.S. Provisional Application No. 62/179,486, filed on May 7, 2015, the subject matter of which is hereby incorporated by reference in its entirety.

### FIELD OF THE INVENTION

The present invention is generally directed to a cinchable ground sheet, and more specifically directed to an assembled, cinchable ground sheet, a kit for making a cinchable ground sheet and methods of using, making, marketing, and demonstrating the same.

### BRIEF SUMMARY

In at least some aspects of the present invention, a ground sheet assembly includes a portable ground sheet having a first section and a plurality of additional sections; a first loop coupled to the first section; and a plurality of additional loops coupled to each of the additional sections, wherein the first loop is operable to bring the first section together with the plurality of additional sections when the first loop is passed through each of the plurality of additional loops.

In other aspects of the present invention, a kit for making a ground sheet assembly includes a first loop attachable to a first portion of the ground sheet; and a plurality of additional loops attachable to other portions of the ground sheet, wherein after attachment of the first loop and the plurality of additional loops, the first loop is operable to bring together the first portion and other portions of the ground sheet when the first loop is passed through each of the plurality of additional loops.

In other aspects of the present invention, a method of demonstrating the assembly of a cinchable ground sheet includes the steps of (1) providing a plurality of loops for purchase; (2) displaying how at least some of the plurality of loops are attachable to the ground sheet; and (3) displaying how a first loop is passable through the each of the other attached loops to cinch various portions of the ground sheet together.

### BRIEF DESCRIPTION OF THE DRAWINGS

Preferred and alternative embodiments of the present invention are described in detail below with reference to the following drawings:

FIG. 1A is a schematic, perspective view of ground sheet assembly according to an embodiment of the present invention;

FIG. 1B is a schematic, plan view of the ground sheet assembly of FIG. 1A according to an embodiment of the present invention;

FIG. 2A is a schematic, perspective view of the ground sheet assembly of FIG. 1A being cinched according to an embodiment of the present invention;

FIG. 2B is a schematic, perspective view of the ground sheet assembly of FIG. 2A having one loop function as a handle loop according to an embodiment of the present invention;

FIG. 2C is a close-up view of the loops in FIG. 2B according to an embodiment of the present invention; and

FIG. 2D is a side elevational view of a ground sheet assembly ready for transport according to an embodiment of the present invention.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with ground sheets, tarps, canvases, tarpaulins, bags, loops, handles, grommets, reinforcement materials, combinations thereof, and methods of making, using, displaying, and marketing the same, have not necessarily been shown or described in detail to avoid unnecessarily obscuring descriptions of the embodiments of the invention.

In at least some embodiments, the present invention is directed to a cinchable ground sheet, and more specifically directed to an assembled, cinchable ground sheet, a kit for making a cinchable ground sheet, and methods of making, using, marketing, and demonstrating the same. For purposes of the description, claims, other text, and drawings herein, a “ground sheet” should be broadly interpreted as any type of tarp, canvas, tarpaulin, or other sheet that can be laid on the ground or on some other surface such that leaves, grass, dirt, or various other types of matter and debris may be placed onto the ground sheet. Further, for purposes of the description, claims, other text and drawings herein, the terms “handle” and “loop” may be interpreted as being interchangeable, one in the same or different features.

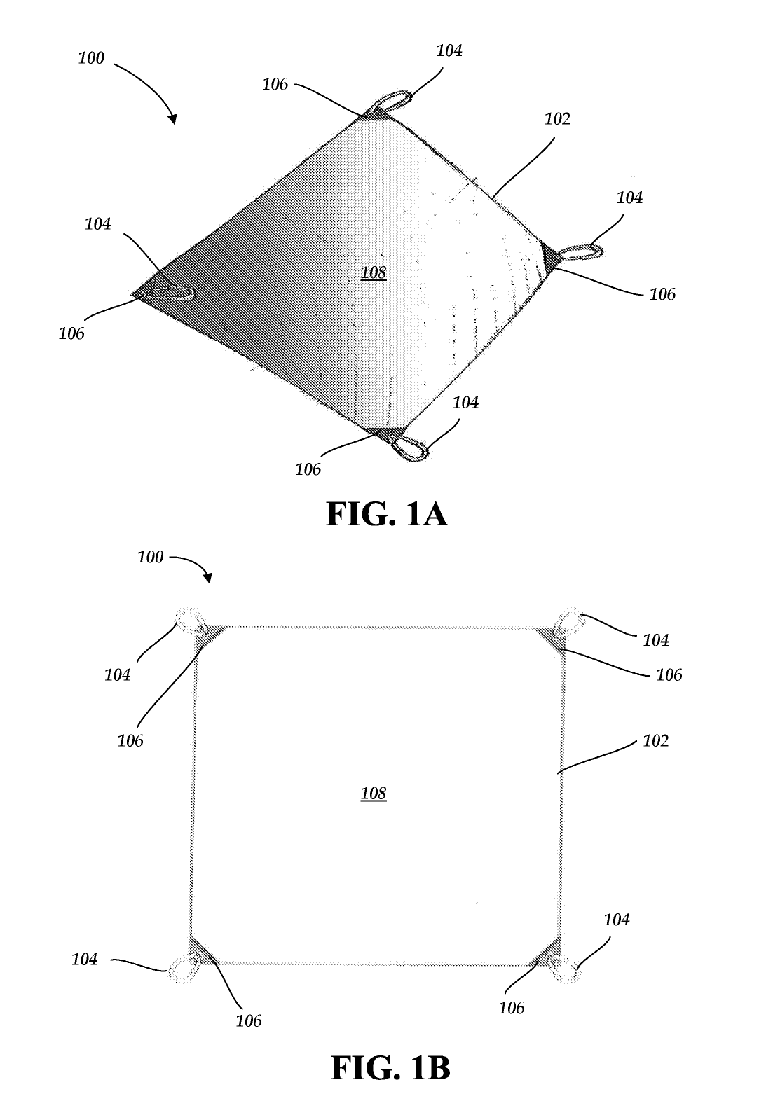

FIG. 1A shows a schematic, perspective view of a ground sheet assembly 100 having a ground sheet 102 and a plurality of loop handles 104 (hereinafter referred to as loops 104) coupled to the corner portions 106 of the ground sheet 102. FIG. 1B shows a plan view of the ground sheet assembly 100 of FIG. 1A.

In at least some embodiments, the ground sheet 102 is constructed of a suitable material for outdoor use and is strong enough and puncture resistant enough for materials and other matter such as, but not limited to, leaves, lawn clippings, dirt, and other debris to be loaded onto a loading surface 108, which can be either surface, for transport. The ground sheet 102 may be made from a fabric material, plastic material, a combination of both, or some other material. The ground sheet 102 is not limited to being square or rectangular, but may take a variety of different shapes, sizes and peripheries that may have more than four corner portions or fewer than four corner portions. For brevity and clarity, the ground sheet assembly 100 described and illustrated herein has four corners. The corner portions 106 may be reinforced with additional material, which may the same material as the ground sheet 102 or a different material. The reinforcement material may be attached to the ground sheet 102 in a variety of ways such as, but not limited to, fastening, adhering, or heat bonding. The sheet material may simply be folded over on itself in the region desired to be reinforced.

The loops 104 are coupled to each corner portion 106. In at least some embodiments, at least one of the loops 104 functions as a handle, which will be described below. Additionally or alternatively, at least one of the loops 104 may be padded with a comfortable and grippable material. The padding may advantageously help distribute the pressure on a person's hand when the ground sheet assembly 100 is being transported.

The loops 104 may be coupled to the corner portions 106 in a variety of ways. In at least one embodiment, the loops 104 each comprise a rope in which both ends of the rope are passed through a grommet or eyelet (not shown) attached to the respective corner portion 106 of the ground sheet 102. In addition, the ends of the rope also pass through a washer (not shown) that is larger than the opening in the grommet. The ends or the rope are tied into a knot or otherwise coupled together to form a stopping feature that is larger than the opening of the washer. Thus, pulling on the loop 104 urges the stopping feature against the washer, urges the washer against the grommet, and neither the stopping feature nor the washer can be pulled through the grommet. By way of example, the use of such a washer on the backside of an installed grommet or eyelet may form a stronger connection than a rope knotted on the backside alone. In some other embodiments, the loops 104 are coupled to the reinforcement material, which is then attached to the ground sheet 102. In yet other embodiments, the loops 104 are crimped or otherwise bound on the backside of the grommet to prevent pull through. It is appreciated and understood that the present invention contemplates any suitable technique for attaching the loops 104 to the corner portions 106 of the ground sheet 102.

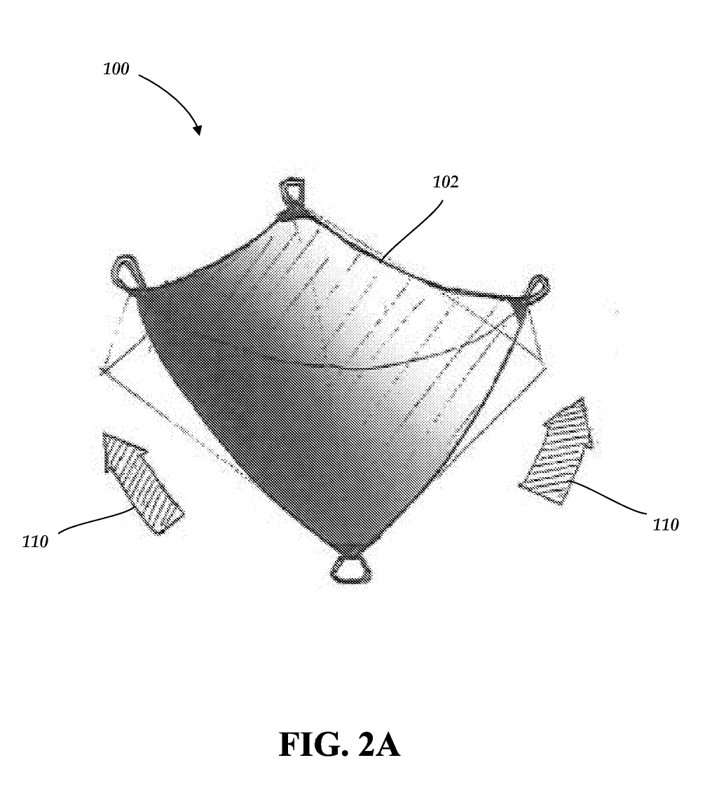

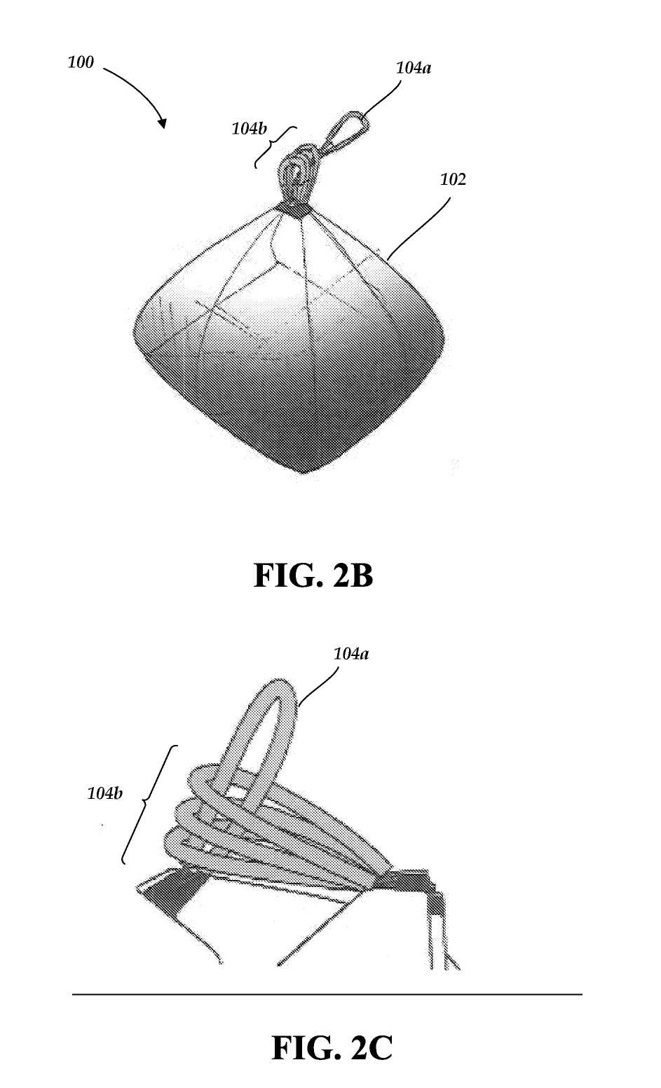

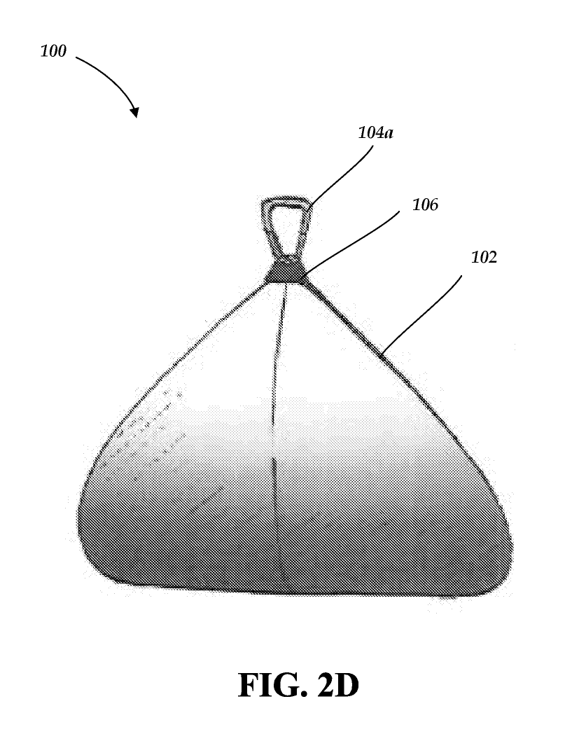

FIGS. 2A-2D show the ground sheet assembly 100 in operation. After debris has been placed on the ground sheet 102, FIG. 2A shows that the loops 104 are brought toward each other as indicated by arrows 110.

FIGS. 2B and 2C show that one of the loops 104 functions first as a cinching mechanism and second as a handle. The ground sheet assembly 100 is cinched together when the loops 104 are interwoven in such a way that a handle loop 104a passes through the remaining loops 104b. The handle loop 104a cinches up the remaining loops 104b as well as the ground sheet 102 and then operates as a handle that allows the ground sheet assembly 100 to be transported with its contents enclosed therein. In at least some embodiments, the handle loop 104a may be used to transport the loaded ground sheet assembly 100 “hobo” style; although other carrying or transporting methods may be employed. In other embodiments, for example when the ground sheet assembly 100 is not full, one of the corner portions may be pulled through the loops 104 to take up slack. Pulling the ground sheet partially through the loops also tends to retain the loops linked together. The handle loop may also include an enlarged loop or other member, such as a toggle, to retain its position coupled through the other loops. Again, it is noted that although the illustrated embodiment shows a ground sheet assembly 100 having four corner portions 106, it is appreciated that the ground sheet assembly 100 may have a greater or lesser number of corner portions. By way of example, the handle loop may be passed through three or more remaining loops. In use, the handle loop may be passed through one or more other loops, depending on the load (and depending on the configuration of the particular ground sheet assembly being used). For example, after partial loading, one or more loops may be used to reposition the ground sheet on the ground for further loading. Alternatively, any of the loops may be passed through any of the other loops, as needed. FIG. 2D shows the ground sheet assembly 100 in a cinched configuration and ready for transport.

In at least some embodiments, the loops 104 may be sold as a kit independently from the ground sheet 102. Such a kit would include the loops 104, but may include other components such as, but not limited to, grommets, washers, knotting instructions, reinforcement material for the corner portions of the ground sheet, etc. Additionally or alternatively, one set of loops 104 may be used on different ground sheets. Also, the loops 104 may be of various sizes depending on the size of the ground sheet, the contents to be placed on the ground sheet, the material of the ground sheet, the method of transportation, as well as other factors.

While preferred embodiments of the invention have been illustrated and described, as noted above, many changes can be made without departing from the spirit and scope of the invention. In addition, other advantages will also be apparent to those of skill in the art with respect to any of the above-described embodiments whether viewed individually or in some combination thereof. Accordingly, the scope of the invention is not limited by the disclosure of the preferred embodiment. Instead, the invention should be determined entirely by reference to the claims that follow.

What is claimed as new and desired to be protected by Letters Patent of the United States is:

1. A ground sheet assembly comprising:
a portable ground sheet having a first section and a plurality of additional sections;
a first loop coupled to the first section; and
a plurality of additional loops coupled to each of the additional sections, wherein the first loop is operable to bring the first section together with the plurality of additional sections when the first loop is passed through each of the plurality of additional loops.

2. The device of claim 1, wherein the first loop and at least one of the plurality of additional loops is padded.

3. The device of claim 1, wherein first section and the plurality of additional sections are corner sections.

4. The device of claim 1, wherein the ground sheet is a tarpaulin.

5. The device of claim 1, wherein the ground sheet is made from a fabric material.

6. The device of claim 1, wherein the ground sheet is made from a plastic material.

7. The device of claim 1, further comprising a grommet coupled to the first section or at least one of the additional sections.

8. The device of claim 1, wherein the first section or at least one of the additional sections includes a reinforced portion.

9. A kit for making a ground sheet assembly, the kit comprising:
a first loop attachable to a first portion of the ground sheet; and
a plurality of additional loops attachable to other portions of the ground sheet, wherein after attachment of the first loop and the plurality of additional loops the first loop is operable to bring together the first portion and other portions of the ground sheet when the first loop is passed through each of the plurality of additional loops.

10. The kit of claim 9, wherein the first loop and at least one of the plurality of additional loops is padded.

11. The kit of claim 9, wherein the first loop includes a knot formed on an opposite side of the ground sheet as the first loop.

12. The kit of claim 9, wherein at least one of the plurality of additional loops includes a knot formed on an opposite side of the ground sheet from the at least one of the plurality of additional loops.

13. A method of demonstrating the assembly of a cinchable ground sheet, the method comprising:
providing a plurality of loops for purchase;
displaying how at least some of the plurality of loops are attachable to the ground sheet; and
displaying how a first loop is passable through the each of the other attached loops to cinch various portions of the ground sheet together.

14. The method of claim 13, wherein providing the plurality of loops includes providing at least one padded loop.

15. The method of claim 13, further comprising displaying how at least one portion of the ground sheet is passable through the each of the other attached loops to cinch various portions of the ground sheet together.

16. The method of claim 13, further comprising displaying how one portion of the ground sheet is passable through one or more loops.
